(19) United States
(12) Patent Application Publication
(10) Pub. No.: US 2023/0151970 A1
(43) Pub. Date: May 18, 2023

(54) DISPLAY AND OPERATING DEVICE AND HOUSEHOLD APPLIANCE

(71) Applicant: BSH Hausgeräte GmbH, Munich (DE)

(72) Inventor: Johannes Ertl, Altenmarkt (DE)

(21) Appl. No.: 17/919,759

(22) PCT Filed: May 5, 2021
(86) PCT No.: PCT/EP2021/061838

§ 371 Date: Oct. 19, 2022

(30) Foreign Application Priority Data
May 11, 2020 (DE) 102020205864.4

(51) Int. Cl. F24C 7/08; B32B 7/12

(52) U.S. Cl. CPC F24C 7/086; B32B 7/12

(57) ABSTRACT

A display and operator control device for a household appliance includes a display facility, a front screen having at least one transparent section and configured to cover the display facility, and an optically clear adhesive configured to fill up an intermediate space between the front screen and the display facility.

The present invention relates to a display and operator control device for a household appliance and to a household appliance with a display and operator control device of this kind.

What is known as an operator control panel for a household appliance, for example for an oven, may comprise a front screen which is transparent at least in sections and a panel carrier which supports the front screen. A contact sensor and a display facility, for example in the form of a TFT display, may be provided on the rear side of the front screen.

EP 2 851 620 A1 shows an operating panel as previously mentioned, in which a display facility in the form of a TFT display is connected to a panel carrier with a positive fit with the aid of a frame. In this context, the display facility is arranged behind a front screen, which is adhesively bonded to the panel carrier.

Against this background, an object of the present invention consists in providing an improved display and operator control device for a household appliance.

Accordingly, a display and operator control device for a household appliance is proposed. The display and operator control device comprises a display facility, a front screen which is transparent at least in sections and which covers the display facility, and an optically clear adhesive, which fills up an intermediate space provided between the front screen and the display facility.

Due to the optically clear adhesive filling up the intermediate space, in comparison with a display and operator control device in which the intermediate space is filled with air, it is possible to prevent dirt particles from penetrating into the intermediate space. At the same time, it is possible to improve the color reproduction and the contrast of the display facility in comparison with an air-filled intermediate space.

The display facility may be what is known as a TFT display (TFT: thin-film transistor). The display facility may also be a light-emitting diode (LED), an organic light-emitting diode (OLED) or the like. In particular, the front screen is a glass screen. The front screen may also, however, be manufactured from a transparent plastic material. For example, the front screen may be manufactured from a polystyrene (PS) or a polycarbonate (PC). The front screen forms an interface between the display and operator control device and a user. The front screen has a front side facing the user and a rear side facing away from the user. The display facility is provided on the rear side. The front screen may be completely transparent. The front screen may also be partially opaque and may only have a transparent section, behind which the display facility is arranged. The transparent section may be square, rectangular or even round. The display facility may be adhesively bonded to the rear side of the front screen with the aid of the optically clear adhesive. In this case, the optically clear adhesive completely fills up the intermediate space. This means that the optically clear adhesive adhesively bonds the front screen to the display facility. It is still also possible, however, for other components, such as a contact sensor for example, to be arranged in the intermediate space. In this case, the optically clear adhesive only partially fills up the intermediate space.

The optically clear adhesive is transparent, so that the display facility can be seen through the optically clear adhesive. The optically clear adhesive has a refraction index which is adapted to the front screen, in order to avoid light refraction and reflections. In particular, the optically clear adhesive has the same refraction index as the front screen. The optically clear adhesive may also be referred to as OCA. The optically clear adhesive may cover or overlay a larger region than the previously mentioned transparent section of the front screen. In the present case, the front screen “covering” the display facility means that the display facility is arranged behind the front screen or on the rear side of the front screen. In particular, the display and operator control device is assigned a coordinate system with an x direction or width direction, a y direction or height direction and a z direction or depth direction. When viewed along the depth direction, the display facility is placed next to or behind the front screen. The intermediate space may also be referred to as a gap.

The display and operator control device may be referred to as operator control panel or display and/or operator control panel. The household appliance can be operated with the aid of the display and operator control device. For example, with the aid of the display and operator control device, a temperature in the interior of a cooking compartment of the household appliance can be set or a program sequence stored in the display and operator control device, for example a baking program, can be selected and started. Furthermore, the display and operator control device is also suitable for displaying operating states of the household appliance. For example, with the aid of the display and operator control device, the temperature within the cooking compartment or a sequence of the previously mentioned baking program can be displayed.

According to one embodiment, the display and operator control device further comprises a contact sensor, which is arranged in the intermediate space, wherein the contact sensor is adhesively bonded to the front screen, and wherein the optically clear adhesive is arranged between the contact sensor and the display facility.

The contact sensor is optional. In the event that no contact sensor is provided, the optically clear adhesive, as previously mentioned, fills up the entire intermediate space provided between the front screen and the display facility and thus adhesively bonds the display facility to the front screen. In the event that no contact sensor is provided, any given other sensor may be provided, which enables the detection of a contact between the user and the front screen. In the event that a contact sensor is provided, it is arranged between the display facility and the front screen. In this context, the contact sensor is adhesively bonded to the rear side of the front screen. In turn, the contact sensor is adhesively bonded to the display facility with the aid of the optically clear adhesive. In particular, the contact sensor is what is known as a touch sensor. The contact sensor is film-like and transparent, so that the display facility can be viewed through the contact sensor.

According to a further embodiment, the optically clear adhesive is a gel.

This means that the optically clear adhesive can be hardened in advance in the manner of a double-sided adhesive tape. This simplifies the operability of the optically clear adhesive. Alternatively, the optically clear adhesive may also be used as a liquid.

According to a further embodiment, the optically clear adhesive is silicone-based or acrylate-based.

However, any given other materials may be used for the optically clear adhesive. With the aid of the optically clear adhesive, the display facility is optically bonded to the front screen.

According to a further embodiment, the optically clear adhesive is elastically deformable.

This makes it possible to mount the display facility in a manner which damps oscillations and is decoupled from impacts. Furthermore, thermal deformations of the components can be compensated. In the present case, “elastic” is to be understood as meaning that the optically clear adhesive can be brought from an undeformed state into a deformed state through the application of a force. As soon as the force is no longer acting on the optically clear adhesive, it automatically brings itself from the deformed state back into the undeformed state. In particular, the optically clear adhesive is resiliently deformable.

According to a further embodiment, the display and operator control device further comprises a panel carrier, which is connected to the front screen.

The panel carrier is preferably a bent sheet component. The panel carrier forms a mechanical interface between the display and operator control device and the household appliance. In particular, the panel carrier is adhesively bonded to the front screen. To this end, an adhesive in the form of a double-sided adhesive tape or a liquid adhesive can be used.

According to a further embodiment, the display and operator control device further comprises a bracing element, which braces the display facility against the panel carrier.

Preferably, the bracing element has an L-shaped cross-section and comprises a long limb, which is connected to the display facility, and a short limb, which is connected to the panel carrier. For example, the bracing element is adhesively bonded to, screwed to, or only braced against the panel carrier.

According to a further embodiment, the bracing element is adhesively bonded to the display facility.

In particular, the long limb of the bracing element is adhesively bonded to the rear side of the display facility.

According to a further embodiment, the bracing element is manufactured from quartz glass, ceramic or a filled plastic.

By using a material with a very low thermal expansion for the bracing element, a force effect due to the deformation, caused by heat, of the bracing element into the display facility is avoided. The plastic may be filled with rock flour or the like, for example. For example, the bracing element may be manufactured from a filled acrylic butadiene styrene (ABS), a filled polybutylene terephthalate (PBT) or another suitable plastic.

Furthermore, a household appliance with a display and operator control device of this kind is proposed.

The household appliance may be any given household appliance, such as a household cooker, a household oven, a household combination microwave oven, a household microwave appliance, a household refrigerator, a household washing machine, a household tumble dryer, a household dishwasher, a household fully automatic coffee machine, a household multifunctional food processor or the like. With the aid of the display and operator control device, the household appliance can be operated and operating states of the household appliance can be displayed.

Further possible implementations of the display and operator control device and/or of the household appliance also comprise combinations—not explicitly mentioned—of features or embodiments described above or below in respect of the exemplary embodiments. In such cases the person skilled in the art will also add individual aspects as improvements or amendments to the respective basic form of the display and operator control device and/or of the household appliance.

Further advantageous embodiments and aspects of the display and operator control device and/or of the household appliance form the subject matter of the subclaims and of the exemplary embodiments of the display and operator control device and/or of the household appliance described below. The display and operator control device and/or the household appliance are further explained in greater detail below on the basis of preferred embodiments with reference to the appended figures.

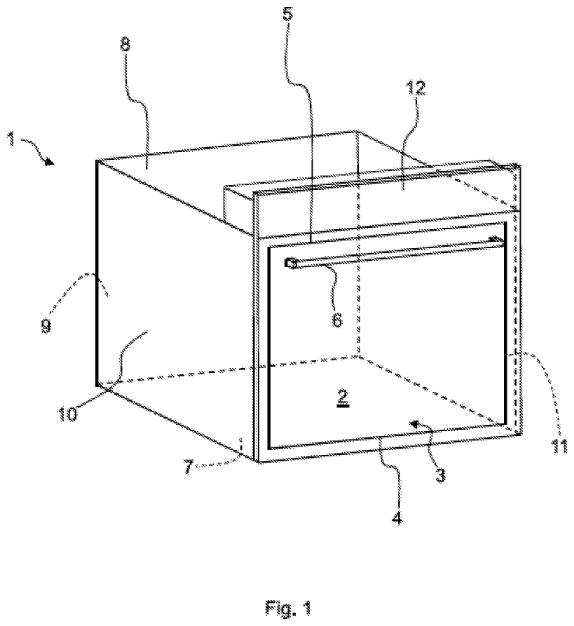

FIG. 1 shows a schematic perspective view of an embodiment of a household appliance;

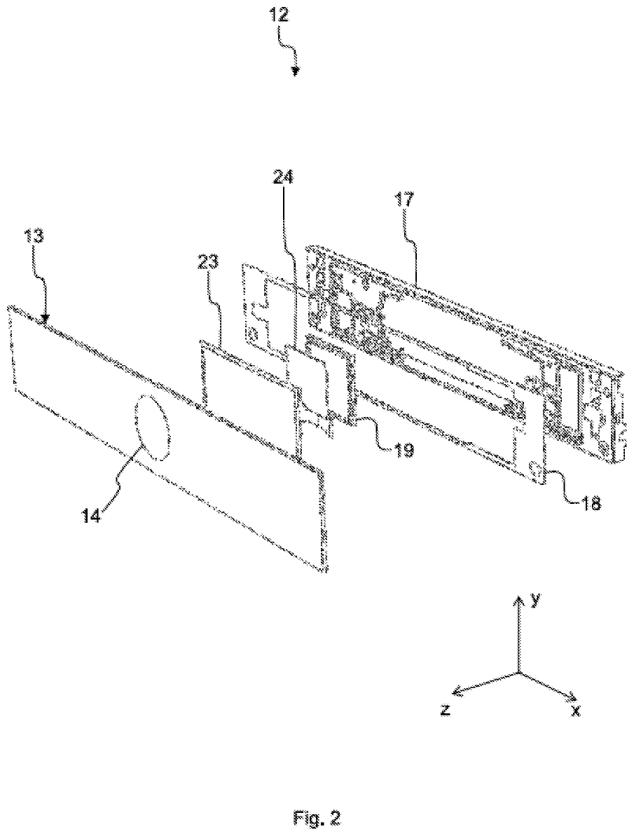

FIG. 2 shows a schematic perspective exploded view of an embodiment of a display and operator control device for the household appliance according to FIG. 1;

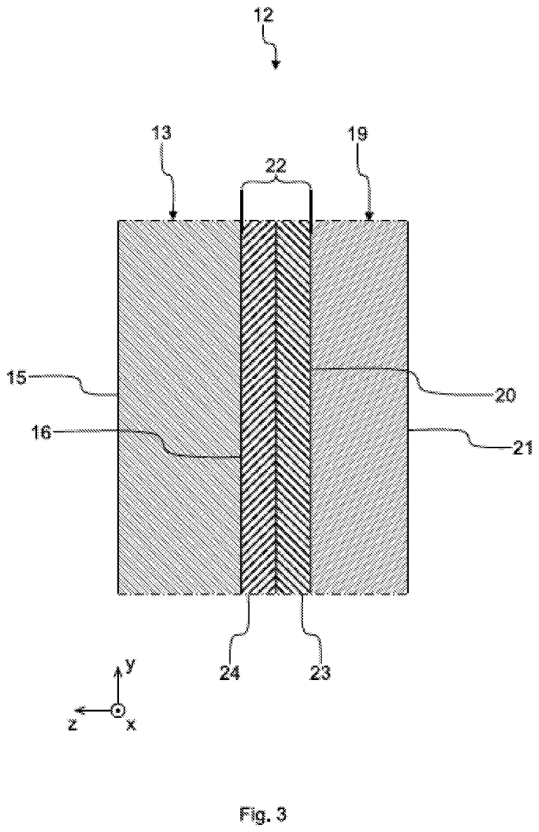

FIG. 3 shows a significantly enlarged schematic partial sectional view of the display and operator control device according to FIG. 2; and

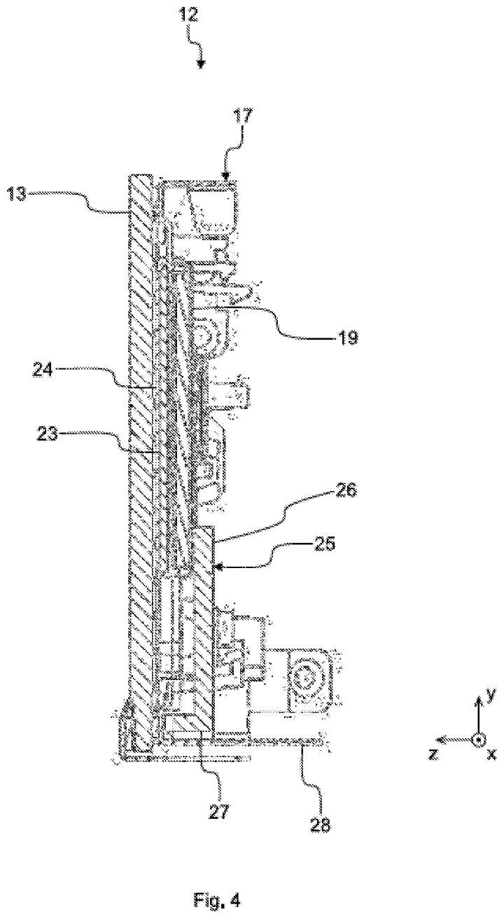

FIG. 4 shows a schematic sectional view of the display and operator control device according to FIG. 2.

In the figures, elements that are identical or have the same function are provided with the same reference characters unless specified otherwise.

FIG. 1 shows a schematic perspective view of an embodiment of a household appliance 1. The household appliance 1 may be an oven, a combination microwave oven, a double oven, a microwave, a refrigerator, a fully automatic coffee machine, a warming drawer, a dishwasher, a washing machine, a dryer or the like. Subsequently it will be assumed, however, that the household appliance 1 is a household cooking appliance, such as an oven for example.

The household appliance 1 has a cooking compartment 2, which can be closed off with the aid of a door 3. The cooking compartment 2 may also be referred to as muffle or oven muffle. The cooking compartment 2 can be arranged in the interior of a housing of the household appliance 1. The door 3 is shown in a closed position in FIG. 1. The door 3 can be closed or opened by pivoting about a pivot axis provided on a lower end of the door 3 or a lower edge 4 of the door 3. Alternatively, the door 3 can be attached laterally to the cooking compartment 2. Furthermore, the door 3 can be arranged on a sliding oven door which can be pulled out from the cooking compartment 2.

A handle 6 can be provided on an upper section or on an upper edge 5 of the door 3. The cooking compartment 2 has a base 7, a ceiling 8 arranged opposite to the base 7, a rear wall 9 arranged facing the closed door 3 and two side walls 10, 11 arranged facing one another. The cooking compartment 2 is preferably box or cube-shaped. The cooking compartment 2 can be produced from a metal material, in particular from sheet steel.

The household appliance 1 furthermore comprises an operator control panel, display and/or operator control panel or display and operator control device 12. The household appliance 1 can be operated with the aid of the display and operator control device 12. For example, with the aid of the display and operator control device 12, a temperature in the interior of the cooking compartment 2 can be set or a program sequence stored in the display and operator control device 12, for example a baking program, can be selected and started. Furthermore, the display and operator control device 12 is also suitable for displaying operating states of the household appliance 1. For example, with the aid of the display and operator control device 12, the temperature within the cooking compartment 2 or a sequence of the previously mentioned baking program can be displayed.

FIG. 2 shows a schematic perspective exploded view of an embodiment of a display and operator control device 12, as previously mentioned, for the household appliance 1. FIG. 3 shows a significantly enlarged partial sectional view of the display and operator control device 12. FIG. 4 shows a schematic sectional view of the display and operator control device 12. Reference is made below simultaneously to FIGS. 2 to 4.

The display and operator control device 12 is assigned a coordinate system with an x direction or width direction x, a y direction or height direction y and a z direction or depth direction z. The directions x, y, z are oriented perpendicularly to one another.

The display and operator control device 12 comprises a front screen 13. The front screen 13 is manufactured from glass. The front screen 13 lies in a plane spanned by the width direction x and the height direction y. The front screen 13 is transparent at least in sections. For example, the front screen 13 may have a transparent region 14 and may otherwise be opaque. Alternatively, the front screen 13 may also be completely transparent. The front screen 13 forms an interface with a user. This means that the user looks at the front screen 13 in order to read out information, and can touch the front screen 13 in order to select and start a program sequence, for example.

The front screen 13 comprises a front side 15 (FIG. 3), which faces the user, and a rear side 16, which faces away from the user. The front screen 13 may have a thickness of 4 mm, for example. The front screen 13 is supported by a panel carrier 17. To this end, the front screen 13 is adhesively bonded to the panel carrier 17 with the aid of an adhesive 18. In particular, the adhesive 18 is applied to the rear side 16 of the front screen 13. The adhesive 18 is preferably a double-sided adhesive tape. This facilitates the application of the adhesive 18. The adhesive 18 has a frame-shaped geometry. The panel carrier 17 is a bent sheet component. The panel carrier 17 is connected to the household appliance 1 in a fixed manner. The panel carrier 17 forms a mechanical interface between the display and operator control device 12 and the household appliance 1.

A display facility 19 is attached to the rear side of the front screen 13. The display facility 19 is a TFT display, for example. In this context, “TFT” stands for “thin-film transistor”. With the aid of the display facility 19, it is possible, for example, to display an operating state of the household appliance 1. The display facility 19 comprises a front side 20 (FIG. 3), which faces the rear side 16 of the front screen 13, and a rear side 21, which faces away from the rear side 16 of the front screen 13. A gap or intermediate space 22 is provided between the front screen 13 and the display facility 19, in particular between the rear side 16 of the front screen 13 and the front side 20 of the display facility 19. The intermediate space 22 may have an extension of 0.1 to 2 mm along the depth direction z, for example.

The intermediate space 22 may be filled up with an optically clear adhesive 23 (OCA) in such a manner that the optically clear adhesive 23 connects the rear side 16 of the front screen 13 to the front side 20 of the display facility 19. This means that the display facility 19 is adhesively bonded to the front screen 13 with the aid of the optically clear adhesive 23. The front screen 13 is thus optically bonded to the display facility 19. The optically clear adhesive 23 may be a silicone, an acrylate or the like. The optically clear adhesive 23 is transparent, so that the display facility 19 can be viewed through the front screen 13 and the optically clear adhesive 23. The optically clear adhesive 23 has a layer thickness of 0.1 to 1.5 mm, in particular of 0.8 mm.

An optional contact sensor 24 may also be arranged in the intermediate space 22. The contact sensor 24 may be what is known as a touch sensor. The contact sensor 24 is in the shape of a film and is adhesively bonded to the rear side 16 of the front screen 13. The contact sensor 24 is likewise transparent. In the event that the contact sensor 24 is provided in the intermediate space 22, the contact sensor 24, as previously mentioned, is adhesively bonded to the rear side 16 of the front screen 13, and the optically clear adhesive 23 adhesively bonds the contact sensor 24 to the front side 20 of the display facility 19.

In the event that no contact sensor 24 is provided, the intermediate space 22 is completely filled up with the optically clear adhesive 23. In this case, any given other sensor may be provided, which is suitable for detecting a contacting of the front screen 13 by the user.

The optically clear adhesive 23 may be a gel, for example. In this case, the optically clear adhesive 23 may be adhesively bonded to the front screen 13 or to the contact sensor 24 in a similar manner to a double-sided adhesive tape. Furthermore, the display facility 19 is pushed onto the optically clear adhesive 23 and is thus connected thereto. This simplifies the application of the optically clear adhesive 23. The optically clear adhesive 23 may also, however, be introduced into the intermediate space 22 as a liquid, where it hardens and/or cures. This means that the optically clear adhesive 23 can either be dosed as a liquid or applied in a prehardened manner as a gel in various sizes appropriate for the display facility 19.

The optically clear adhesive 23 is elastically, in particular resiliently, deformable. In the present case, “elastic” means that the optically clear adhesive 23 can be brought from an undeformed state into a deformed state with the aid of an application of a force. As soon as the force is no longer acting on the optically clear adhesive 23, it automatically deforms from the deformed state back into the undeformed state. This enables a dampened mounting of the display facility 19, for example in such a manner that vibrations of the household appliance 1, for example of a fan of the household appliance 1, are not transferred to the display facility 19. This increases the service life of the display facility 19.

A joining process for connecting the display facility 19 to the front screen 13 or to the contact sensor 24 may take place in a clean room, in order to avoid contamination due to particles or the like. In particular, a subassembly comprising the front screen 13, the contact sensor 24, the optically clear adhesive 23 and the display facility 19 may be joined in a specific vacuum bonding installation, in order to prevent air bubbles between the front screen 13 or between the contact sensor 24 and the optically clear adhesive 23 and between the optically clear adhesive 23 and the display facility 19. Additionally, the adhesion properties of the joining partners can be increased with the aid of a preceding surface activation, for example with the aid of UV light, plasma treatment or the like. Once the display facility 19 has been assembled on the front screen 13, the panel carrier 17 can be adhesively bonded to the front screen 13 with the aid of the adhesive 18.

The use of the optically clear adhesive 23 as a prehardened gel make elaborate dosing and joining installations redundant. The gel is first applied in the manner of a double-sided adhesive tape to the front screen 13 or to the contact sensor 24 attached thereto, and subsequently the display facility 19 is applied to a rear side of the optically clear adhesive 23 that faces away from the front screen 13. The reverse procedure is likewise possible. The optically clear adhesive 23 in the form of the gel, in particular on a silicone basis, then hardens, without fully hardening in the process. In this context, the optically clear adhesive 23, as previously mentioned, remains flexible and is able to absorb impacts as a result and also does not introduce stresses, which could lead to what are known as mura effects on the display facility 19 for example, into the display facility 19. In this context, a large section of the gel can be used for a plurality of display facilities 19 or a suitably tailored amount of the optically clear adhesive 23 can be used for each display facility 19. The gel, in the form of the optically clear adhesive 23, can be detached again within the first few hours after assembly. This means that the display facility 19 and the front screen 13, after they have been cleaned, can be reused and rebonded.

Due to the intermediate space 22 being filled with the optically clear adhesive 23, which preferably has the same refraction index as the front screen 13, reflections are reduced in comparison with an air-filled intermediate space (not shown). This results in what is known as a black-panel effect. This improves the contrast and the color reproduction of the display facility 19. At the same time, the intermediate space 22 is sealed off from external influences and the display facility 19 is fixed, without introducing additional forces into the connection between the front screen 13 and the panel carrier 17.

The display and operator control device 12 further comprises a bracing element 25 shown in FIG. 4, which braces the display facility 19 against the panel carrier 17. The bracing element 25 has an L-shaped cross-section and comprises a long limb 26 and a short limb 27. The limbs 26, 27 are positioned perpendicularly to one another. The long limb 26 can be adhesively bonded to the rear side 21 of the display facility 19. The short limb 27 is connected to a plate-shaped lower section 28 of the panel carrier 17, for example is adhesively bonded thereto.

With the aid of the bracing element 25, a risk of the display facility 19, and also individual layers of the display facility 19, of which the display facility 19 is constructed, sagging over the overall service life of the household appliance 1 can be significantly reduced. Through the adhesive bonding of the bracing element 25 to the rear side 21 of the display facility 19, the position of the display facility 19 can be fixed independently of the tolerance setting of the individual components. The bracing element 25 fixes the display facility 19 in its position on a permanent basis. In order to avoid force effects due to thermal expansions of the bracing element 25, the bracing element 25 is itself produced from a material with very low thermal expansion. For example, the bracing element 25 may be manufactured from quartz glass, ceramic or a highly filled plastic. The plastic may be filled with rock flour or the like, for example. For example, a filled acrylonitrile butadiene styrene (ABS) is used as material for the bracing element 25.

The application of the bracing element 25 after the adhesive bonding of the display facility 19 to the front screen 13 and the adhesive bonding of the front screen 13 to the panel carrier 17 decouples the process of the attachment of the bracing element 25 from the joining tolerances of the preceding assembly steps. A variant of the bracing element 25 can be used in different display facilities 19, as the position at which the bracing element 25 is adhesively bonded to the display facility 19 from behind is flexible.

Although the present invention has been described with reference to exemplary embodiments, it can be modified in numerous different ways.

### REFERENCE CHARACTERS USED

1 Household appliance
2 Cooking compartment
3 Door
4 Lower edge
5 Upper edge
6 Handle
7 Base
8 Ceiling
9 Rear wall
10 Side wall
11 Side wall
12 Display and operator control device
13 Front screen
14 Region
15 Front side
16 Rear side
17 Panel carrier
18 Adhesive
19 Display facility
20 Front side
21 Rear side
22 Intermediate space
23 Adhesive
24 Contact sensor
25 Bracing element
26 Limb
27 Limb
28 Section
x Width direction
y Height direction
z Depth direction

1-10. (canceled)

11. A display and operator control device for a household appliance, comprising:
a display facility;
a front screen having at least one transparent section and configured to cover the display facility; and
an optically clear adhesive configured to fill up an intermediate space between the front screen and the display facility.

12. The display and operator control device of claim 11, further comprising a contact sensor arranged in the intermediate space and adhesively bonded to the front screen, said optically clear adhesive being arranged between the contact sensor and the display facility.

13. The display and operator control device of claim 11, wherein the optically clear adhesive is a gel.

14. The display and operator control device of claim 11, wherein the optically clear adhesive is silicone-based or acrylate-based.

15. The display and operator control device of claim 11, wherein the optically clear adhesive is elastically deformable.

16. The display and operator control device of claim 11, further comprising a panel carrier connected to the front screen.

17. The display and operator control device of claim 16, further comprising a bracing element configured to brace the display facility against the panel carrier.

18. The display and operator control device of claim 17, wherein the bracing element is adhesively bonded to the display facility.

19. The display and operator control device of claim 17, wherein the bracing element is manufactured from quartz glass, ceramic or a filled plastic.

20. A household appliance, comprising a display and operator control device, said display and operator control device for a household appliance, comprising a display facility, a front screen having at least one transparent section and configured to cover the display facility, and an optically clear adhesive configured to fill up an intermediate space between the front screen and the display facility.

21. The household appliance of claim 20, wherein the display and operator control device comprises a contact sensor arranged in the intermediate space and adhesively bonded to the front screen, said optically clear adhesive being arranged between the contact sensor and the display facility.

22. The household appliance of claim 20, wherein the optically clear adhesive is a gel.

23. The household appliance of claim 20, wherein the optically clear adhesive is silicone-based or acrylate-based.

24. The household appliance of claim 20, wherein the optically clear adhesive is elastically deformable.

25. The household appliance of claim 20, wherein the display and operator control device comprises a panel carrier connected to the front screen.

26. The household appliance of claim 25 wherein the display and operator control device comprises a bracing element configured to brace the display facility against the panel carrier.

27. The household appliance of claim 26, wherein the bracing element is adhesively bonded to the display facility.

28. The household appliance of claim 26, wherein the bracing element is manufactured from quartz glass, ceramic or a filled plastic.
